(19) United States
(12) Patent Application Publication
(10) Pub. No.: US 2004/0140751 A1
(43) Pub. Date: Jul. 22, 2004

(54) Display tube and display device

(76) Inventors: Nijs Cornelis Van Der Vaart, Eindhoven (NL); Willibrordus Adrianus Johannes Antonius Van Der Poel, Eindhoven (NL); Daniel Martijn Damen, Eindhoven (NL)

Correspondence Address: Philips Electronics North America Corporation, Corporate Patent Counsel, PO Box 3001, Briarcliff Manor, NY, 10510, US

(21) Appl. No.: 10/479,092

(22) PCT Filed: May 30, 2002
(86) PCT No.: PCT/IB02/01948

(30) Foreign Application Priority Data
Jun. 1, 2001 (EP) 012021119
Nov. 27, 2001 (EP) 012045605

(51) Int. Cl. H01J 29/46

(52) U.S. Cl. 313/441

(57) ABSTRACT

A display tube comprises an electron source (10), a module (20) provided with a guidance cavity (25R, 25G, 25B) for guiding electrons emitted by the electron source (10) to an exit aperture (27R, 27G, 27B) of the guidance cavity (25R, 25G, 25B) and beam-shaping means (30) for forming an electron beam (EBR, EBG, EBB) from guided electrons leaving the exit aperture (27R, 27G, 27B). The electron beam (EBR, EBG, EBB) travels towards a display screen (3). The beam-shaping means (30) are arranged to change a direction in which the electron beam (EBR, EBG, EBB) leaves the guidance cavity (25R, 25G, 25B) in accordance with a predetermined application. For example, the electron beam (EBR, EBG, EBB) is deflected to realize gun pitch modulation in the electron gun of a cathode ray tube. As the electron beam is deflected near the exit aperture (27R, 27G, 27B), spot errors are reduced and the display tube has a relatively high image quality.

The invention relates to a display tube comprising

an electron source for emitting electrons;

a module comprising a guidance cavity having an entrance aperture for receiving electrons emitted by the electron source, an exit aperture, and a wall for emitting a secondary electron after receiving an electron, the exit aperture being situated in an end face of the module;

beam-shaping means for forming an electron beam from secondary electrons near the exit aperture, and

a display screen for receiving the electron beam and for generating an image by means of the electron beam.

The invention also relates to a display device comprising such a display tube.

An embodiment of such a display tube is the cathode ray tube which is known from WO 01/26131. The cathode ray tube comprises a “Hopping Electron Cathode” electron gun, hereinafter also referred to as HEC electron gun. Such an electron gun comprises the module which is provided with a guidance cavity.

At least a part of the wall of the guidance cavity comprises an emitter material which, after reception of an incident electron, emits a secondary electron. The emitter material is preferably insulating and has a secondary electron emission coefficient δ. This indicates the number of secondary electrons which is released from the emitter material as a result of the incidence of an electron with energy Ep on the emitter material.

The beam-shaping means comprise a hop electrode for applying a first electric field of strength E1 which substantially provides transport of secondary electrons to the exit aperture.

If a surface of the exit aperture is small with respect to a surface of the entrance aperture, the guidance cavity acts as an electron concentrator. The electron beam formed at the location of the exit aperture then has a relatively high beam current density.

Such a display tube may be provided with an application in which the path of the electron beam changes.

For example, a color cathode ray tube with three electron beams provided with what is called “Gun Pitch Modulation” is known from international patent application WO 99/34392. In this cathode ray tube, the paths of the outer electron beams are changed in dependence upon a landing spot of the electron beam. In particular, the paths are changed in the electron gun of the cathode ray tube. To this end, apertures formed for passing the outer electron beams in the electrodes are offset with respect to each other in two adjacent electrodes. The two adjacent electrodes are preferably situated near a beam-shaping section of the electron gun.

Another application is what is called the ion trap in which the path of the electron beam changes so as to inhibit damage of the module and/or the electron source due to positive ions released by the electrons. In a cathode ray tube with an electron gun, an ion trap can be formed, for example, by shifting one of the electrodes in the focusing section with respect to the electron-optical axis of the electron gun.

The known display tube has the drawback that the displayed image has a relatively low quality when such an application is used.

It is an object of the invention to provide a display tube of the type described in the opening paragraph in which the image quality is improved.

This object is achieved in a display tube according to the invention, which is characterized in that the beam-shaping means are adapted to adjust, in operation, the exiting direction of the electron beam in conformity with a predetermined application.

The invention is based on the recognition that the display of the electron beam on the display screen deteriorates in the known display tube because the distance between the location where the path of the electron beam is changed and the exit aperture is relatively large. As described previously, a change of the path of the electron beam in known display tubes is generally realized in that at least one of the components of the display tube, for example an electrode of an electron gun has been shifted.

The image of the electron beam on the display screen then deteriorates. The exit aperture does not coincide with a virtual object from which the electron beam, viewed from the display screen, exits. The image of the electron beam on the display screen is not the image of the exit aperture required for displaying a high quality image.

In the invention, the beam-shaping means are situated close to the exit aperture. Consequently, the exiting direction can be adjusted in conformity with the desired application, for example, gun pitch modulation. Since the path of the electron beam can now be changed at the location of the exit aperture, the virtual object always coincides with the exit aperture so that the image of the electron beam on the display screen has a relatively good quality.

The beam-shaping means may comprise a deflection electrode having two segments which, in operation, receive different voltages. To this end, the segments are insulated. Generally, the deflection electrode is arranged parallel to the end face of the module.

If one segment of the deflection electrode receives a larger voltage than the other segment, the exiting direction of the electron beam receives a component in a direction parallel to the end face. The electron beam is deflected in the direction of the segment receiving the largest voltage. The exiting direction of the exiting electron beam is thus changeable by varying the voltage difference between the segments.

In an embodiment of a color display tube, the module has three transport cavities whose exit apertures are aligned in the end face in a first direction for forming an inner electron beam, a first outer electron beam and a second outer electron beam.

In this embodiment, the change of the mutual exit angle of the electron beams by the beam-shaping means is possible, for which purpose the deflection electrodes for the outer electron beams have an inner segment facing the inner electron beam and an outer segment facing away from the inner electron beam. In operation, the inner segments receive the first voltage V1 and the outer segments receive the second voltage V2.

One application is to give the so-termed convergence kink to the outer electron beams in a color cathode ray tube.

In general, the outer electron beams in a color cathode ray tube should have a small deflection towards the inner electron beam so that a good convergence of the electron beams on the display screen is guaranteed. In a color cathode ray tube according to the invention, this convergence kink can be easily implemented in that the mutual exit angle of the electron beams is reduced to a small extent. The convergence kink is given at the location of the exit aperture so that the image of the electron beams on the display screen has a relatively high quality.

In a further advantageous embodiment, the display tube comprises deflection means for changing a landing spot of the electron beams on the display screen. Generally, the entire display screen can thus be written with the electron beams. It is then advantageous if the mutual exit angle of the electron beams is dynamically variable in dependence upon the landing spot of the electron beams on the display screen.

A conventional color display tube has a display screen which is provided with pixels comprising a corresponding phosphor for each electron beam. To ensure that each electron beam on the display screen lands on its corresponding phosphor, the display tube is provided with color selection means.

The color selection means may comprise a shadow mask near the display screen. The electron beams pass each at a different angle of incidence through a common aperture in the shadow mask. The angle of incidence is such for each beam that it lands on the corresponding phosphor of a pixel on the display screen.

It is desirable that the display screen of a display tube is as flat as possible. In the known display tube this means that a shadow mask should also be substantially flat. A substantially flat shadow mask has, however, a relatively small shape stability so that it is, for example, sensitive to vibrations and doming.

It is then advantageous if the shadow mask has a smaller radius of curvature at least in one direction than a radius of curvature of an inner side of the display screen facing the module. The distance between the shadow mask and the display screen is then larger near the edges of the display screen than in the center. The display screen may be substantially flat while the shadow mask has a certain curvature.

The outer electron beams are then to pass the shadow mask at a smaller angle of incidence as they land closer to the edge of the display screen. In this way, the convergence of the electron beams on the corresponding phosphor is ensured throughout the display screen, while the distance between the display screen and the shadow mask changes.

To this end, the mutual exit angle of the electron beams is reduced by the beam-shaping means as the electron beams land closer to the edge of the display screen.

In a further embodiment of the color display tube, the beam-shaping means vary the exiting direction of at least a first electron beam in dependence upon the beam current of at least the first electron beam.

If the beam current of the first electron beam is large with respect to the mutual distance between the first electron beam and an adjacent electron beam, the mutual Coulomb interaction between the first and the adjacent electron beam is relatively strong.

Due to the Coulomb interaction, the angle of incidence of the electron beams near the shadow mask may change. Now, the electron beams do not land completely on the corresponding phosphor.

This can be observed in the image as a color error in a displayed pixel. The displayed colors deviate from the desired colors, notably in the light colors such as white.

If the beam-shaping means deflect the outer electron beams more outwardly with an increasing beam current, the change of the angle of incidence due to Coulomb interaction can at least partly be compensated. The color uniformity is improved.

In a preferred embodiment, the beam-shaping means comprise hop electrodes for transporting secondary electrons in the relevant guidance cavity substantially towards the exit apertures.

This is advantageous because a higher voltage is generally required for transporting the secondary electrons than for changing the exiting direction of at least one of the electron beams. The hop electrode receives a hop voltage Vhop for transporting the secondary electrons, which voltage is larger than the first voltage V1 and the second voltage V2.

The hop electrodes and the deflection electrodes are preferably situated substantially in the same plane near the end face of the module, each hop electrode being situated within an aperture in the respective deflection electrode.

This configuration acts as a planar electron lens on the electron beams exiting from the guidance cavity. The diameter of the electron beams is adjustable so that the main lens can be filled as satisfactorily as possible by the electron beams. Moreover, the voltages Vhop, V1 and V2 are relatively limited in this configuration.

These and other aspects of the invention are apparent from and will be elucidated with reference to the embodiments described hereinafter.

In the drawings:

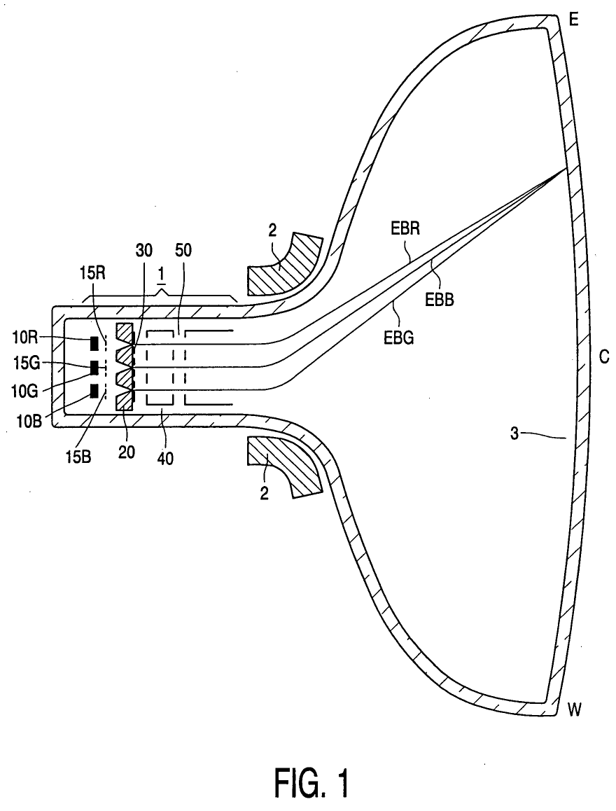

FIG. 1 shows an embodiment of a display tube according to the invention;

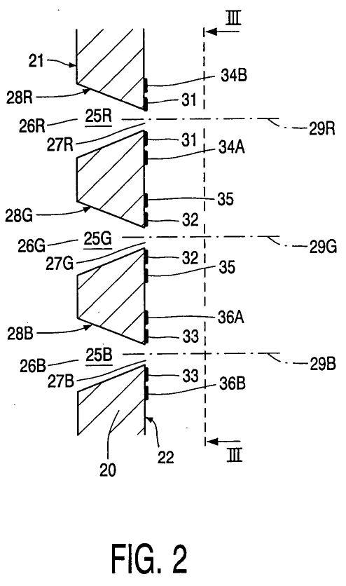

FIG. 2 is a cross-section of the module with the hop electrodes and first electrodes;

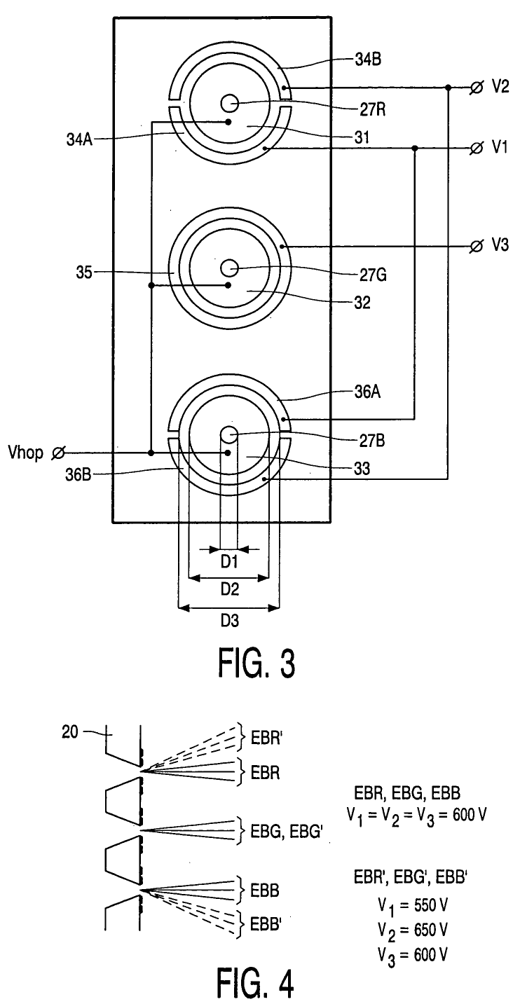

FIG. 3 is a front elevation of the module with the hop electrodes and first electrodes;

FIG. 4 shows diagrammatically the change of the convergence of the electron beams exiting from the module;

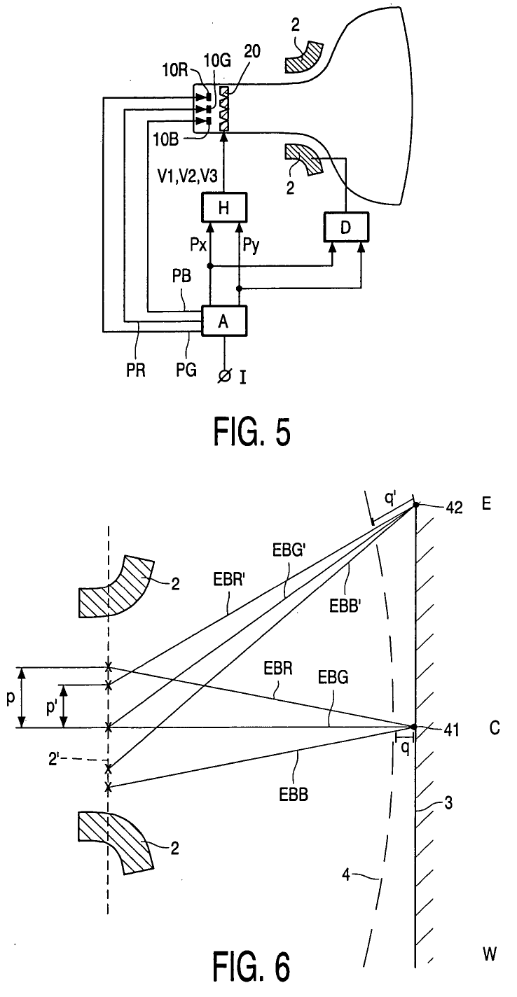

FIG. 5 shows a first embodiment of a display device according to the invention;

FIG. 6 shows diagrammatically a detail of the first embodiment;

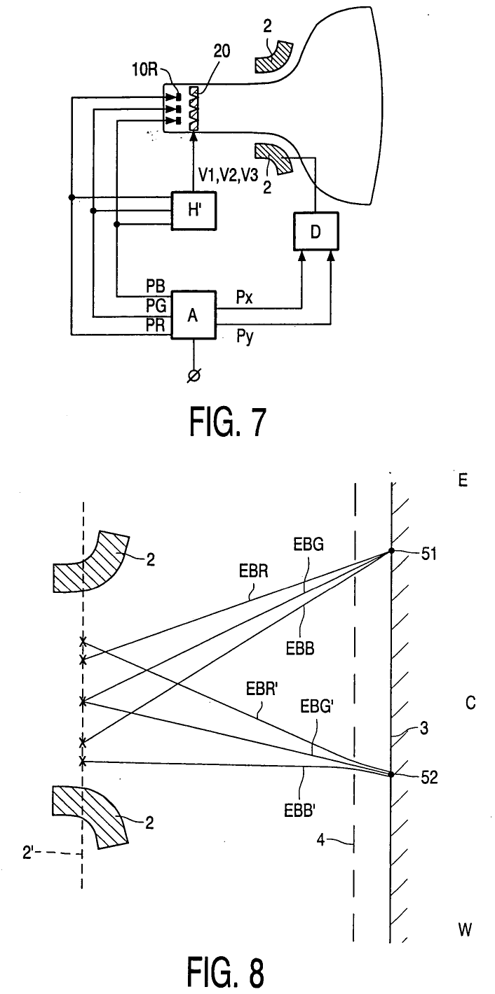

FIG. 7 shows a second embodiment of a display device according to the invention;

FIG. 8 shows diagrammatically a detail of the second embodiment.

An embodiment of the display tube according to the invention is a color cathode ray tube CRT as shown in FIG. 1. In this tube, the electron-optical system 1 generates three electron beams EBR, EBG, EBB and focuses them by means of a main lens 50, which is present in the electron-optical system 1, on the display screen 3.

To be able to change the landing spot of the electron beams EBR, EBG, EBB on the display screen 3, deflection means 2, which are self-convergent in the horizontal direction, surround the neck of the cathode ray tube. The electron gun 1 is a HEC electron gun provided with a module 20 with transport cavities 25R, 25G, 25B for transporting electrons.

For each guidance cavity 25R, 25G, 25B, the cathode ray tube is provided with separate and corresponding electron sources 10R, 10G, 10B, respectively. This is a thermionic cathode in which, in operation, electrons are emitted by heating the cathode by means of a filament.

Separate second electrodes 15R, 15G, 15B for applying a second electric field are arranged between each electron source 10R, 10G, 10B and the module 20. This second electric field withdraws released electrons from the electron sources 10R, 10G, 10B and accelerates them to the associated transport cavities 25R, 25G, 25B of the module 20.

By changing the strength of the second electric field by means of the second electrodes 15R, 15G, 15B, the number of electrons entering the associated transport cavities 25R, 25G, 25B can be adapted and hence the current density of the associated electron beams EBR, EBG, EBB can be modulated at the location of the exit apertures 27R, 27G, 27B. The second electrodes 15R, 15G, 15B are, for example, grids consisting of molybdenum, with an electron transmission of 60%.

The module 20 is shown in greater detail in FIGS. 2 and 3. The module 20 has transport cavities 25R, 25G, 25B each having entrance apertures 26R, 26G, 26B and exit apertures 27R, 27G, 27B, respectively. The transport cavities 25R, 25G, 25B have, for example, a frusto-conical shape which is symmetrical around the central axes 29R, 29G, 29B. At least a part of the walls 28R, 28G, 28B of the transport cavities 25R, 25G, 25B near the exit apertures 27R, 27G, 27B consists of emitter material having an electron emission coefficient δ for emitting a secondary electron after receiving an electron.

Hop electrodes 31, 32, 33 are present near each exit aperture 27R, 27G, 27B on the end face 22 of the module 20 in which the exit apertures 27R, 27G, 27B are situated. The hop electrodes 31, 32, 33 receive a hop voltage Vhop for applying a first electric field E1 which transports the secondary electrons in the transport cavities 25R, 25G, 25B to the exit apertures 27R, 27G, 27B.

The transport cavities transport the electrons by means of a hop process in which as many electrons leave the transport cavities as enter them. To this end, the electron emission coefficient δ of the emitter material should on average be equal to 1 over the transport cavities.

It is then advantageous if the emitter material has a relatively high maximum electron emission coefficient δmax. The field strength of the first electric field E1 and hence the hop voltage Vhop can then remain relatively limited. Vhop is, for example, 1000 volts. The emitter material comprises, for example, magnesium oxide (MgO) and may have a layer thickness of 0.5 micrometer. Alternatively, the emitter material may comprise glass, polyamide, yttrium oxide (Y₂O₃) or silicon nitride (Si₃N₄).

Moreover, a part of the initial face 21 of the module 20, in which the exit apertures 26R, 26G, 26B are situated, is provided with the emitter material.

This provides an advantage if the electron sources 10R, 10G, 10B are eccentric with respect to the transport cavities 25R, 25G, 25B so that emitted electrons land next to the entrance apertures 26R, 26G, 26B on the initial face 21 where they release secondary electrons. It is thereby substantially prevented that electrons emitted by the electron sources 10R, 10G, 10B directly reach the transport cavities 25R, 25G, 25B and exit from the exit apertures 27R, 27G, 27B. These electrons have a larger energy than the secondary electrons and influence the image of the electron beams EBR, EBG, EBB.

The module 20 may comprise aluminum oxide (Al₂O₃) in which the transport cavities 25R, 25G, 25B are arranged. The entrance apertures 26R, 26G, 26B in the initial face 21 are circular apertures having a diameter of, for example, 2.5 millimeters. The exit apertures 27R, 27G, 27B in the end face 22 are circular apertures having a diameter of, for example, 40 micrometers. The angle at which the walls 28R, 28G, 28B extend to the central axes 29R, 29G, 29B is, for example, 35 degrees.

The first electrodes 34, 35, 36 are arranged concentrically with respect to the hop electrodes 31, 32, 33 near the end face 22. For each exiting electron beam EBR, EBG, EBB, the hop electrodes 31, 32, 33 and the first electrodes 34, 35, 36 jointly constitute a planar electron lens. The electrodes 31 to 36 have a thickness L1 of, for example, 2.5 micrometers.

Such an electrode configuration can be made by vapor-depositing a metal layer on a part of the end face 22. The metal layer comprises, for example, chromium and aluminum. Subsequently, the desired configuration of the hop electrodes 31, 32, 33 and the first electrodes 34, 35, 36 can be provided in the metal layer.

The module 20 comprises an insulating material, for example aluminum oxide (Al₂O₃) which, in operation, can charge locally. This disturbs the electric field near the exit apertures 27R, 27G, 27B and may change the shape of the electron beams EBR, EBG, EBB to an unwanted extent. The electrodes 31 to 36 give the end face 22 near the exit apertures 27R, 27G, 2713 an optimally large metal cladding so as to inhibit charging.

The end face 22 coincides with the object plane of the main lens 50. In operation, the main lens 50 thereby forms an electron-optical image of the exit apertures 27R, 27G, 27B on the display screen 3. After exiting from the module 20, the electron beams EBR, EBG, EBB pass a focusing electrode 40 for accelerating the exiting electrons near the exit apertures 27R, 27G, 27B, the main lens 50 and the deflection means 2, before landing on the display screen 3.

The hop electrodes 31, 32, 33 have a circular shape with a diameter D2 and are provided with an aperture for passing the exiting electrons at the location of the exit apertures 27R, 27G, 27B. The diameter D1 of the aperture is substantially equal to that of the exit aperture 27, for example, 40 micrometers.

The first electrodes 34, 35, 36 have a circular aperture with an inner diameter D3 within which the respective hop electrodes 31, 32, 33 are arranged concentrically.

The distance D3-D2 between the first electrodes 34, 35, 36 and the hop electrodes 31, 32, 33 should be such that there is no discharge in the vacuum between the electrodes 31 to 36 under the influence of the voltage difference between the electrodes. To this end, D2 is, for example, 200 micrometers and D3 is, for example, 225 micrometers.

The first electrodes 34, 36 of the outer electron beams EBR, EBG, EBB consist of an inner segment 34A, 36A facing the inner electron beam EBG and an outer segment 34B, 36B remote from the inner electron beam EBG. The inner segments receive a first voltage V1 and the outer segments receive a second voltage V2.

Furthermore, the first electrode 35 of the inner electron beam EBG receives a third voltage V3. The third voltage V3 has a constant value of, for example, 600 volts. The first voltage V1 and the second voltage V2 are generally variable around V3.

By changing the voltage difference V2−V1, the convergence of the electron beams EBR, EBG, EBB exiting from the module 20 can be changed. This is shown in FIG. 4.

If V1=V2=V3, the electron beams EBR, EBG, EBB exit in parallel from the respective transport cavities 25R, 25G, 25B.

The exiting electron beams EBR′, EBG′, EBB′ diverge because a positive voltage difference V2−V1 has been applied such that V1<V3<V2. In particular, V1 is 550 volts, V3 is 600 volts and V2 is 650 volts. Alternatively, the exiting electron beams can be made to converge by applying a negative voltage difference V2−V1, such that V2<V3<V1. This is not shown in the Figure.

In the first embodiment of the display device shown in FIG. 5, the voltage difference V2−V1 is changeable in dependence upon the landing spot of the electron beams EBR, EBG, EBB on the display screen 3.

The display device receives picture information 1 to be displayed which is converted by a control unit A into position signals Px, Py and modulation signals PR, PG, PB.

The position signals Px, Py are applied to a deflection circuit D which generates a deflection current therefrom for controlling the deflection means 2. The modulation signals PR, PG, PB are applied to the electron sources 10R, 10G, 10B for controlling the electron emission by the electron sources 10R, 10G, 10B and thereby modulating the beam current density of the electron beams EBR, EBG, EBB.

Moreover, the position signals Px, Py are applied to a hop circuit H which supplies voltages V1, V2, V3 to the hop electrodes 31, 32, 33 and the first electrodes 34, 35, 36. Particularly, the hop circuit H varies the difference between the voltages V1, V2 in dependence upon the position signals Px, Py.

The difference between the voltages V1, V2 increases as the electron beams EBR, EBG, EBB land further away from the center C of the display screen 3. Consequently, the electron beams EBR, EBG, EBB become more divergent for a larger deflection near the exit aperture 27R, 27G, 27B. As already described, the picture quality of the cathode ray tube according to the invention is thereby improved.

In the first embodiment of the display device, the cathode ray tube comprises a shadow mask 4 near the display screen 3. The shadow mask 4 has a radius of curvature which is smaller than a radius of curvature of the inner side of the display screen 3. This is illustrated in greater detail in FIG. 6.

The electron beams EBR, EBG, EBB land on a pixel 41 in the center of the display screen and have a mutual distance p of, for example, 6.5 millimeters at the area of a deflection plane 2′. This mutual distance will hereinafter be referred to as “gun pitch”. Near the center C of the display screen 3, the shadow mask 4 and the display screen have a mutual distance q. Each electron beam EBR, EBG, EBB is incident, through a common aperture in the shadow mask 4, on the corresponding phosphor of the pixel 41 on the display screen 3.

The electron beams EBR′, EBG′, EBB′ land near a corner E of the display screen 3 and are deflected for this purpose at the area of the deflection plane 2′. In the deflection plane 2′, they have a gun pitch p′ which is larger than the gun pitch p of the electron beams EBR, EBG, EBB, for example, p′ is 5.5 mm.

Near the corner E of the display screen 3, the shadow mask 4 and the display screen 3 have a relatively large mutual distance q′. Since the gun pitch p′ is reduced, the angle of incidence of the outer electron beams EBR′, EBB′ with the shadow mask 4 is reduced. As a result, the beams land on the corresponding phosphor of the pixel 42, in spite of the relatively large distance q′ between the shadow mask 4 and the display screen 3.

The second embodiment of the display device is shown in FIG. 7. The difference between the voltages V1, V2 is changeable in dependence upon the beam current of the electron beams EBR, EBG, EBB.

In the second embodiment, the hop circuit H′ receives the modulation signals PR, PG, PB. The hop circuit H′ now varies the voltages V1, V2 in dependence upon the modulation signals PR, PG, PB. For example, the difference between the voltages V1, V2 increases when the sum PR+PG+PB of the modulation signals PR, PG, PB becomes larger.

Consequently, the color uniformity is improved, notably for light colors such as white. In light colors, the sum of the modulation signals PR, PG, PB is relatively large and there is a relatively strong Coulomb repellence between the electron beams EBR, EBG, EBB near the shadow mask 4. This is illustrated in greater detail in FIG. 8.

The electron beams EBR, EBG, EBB display a dark grey pixel 51, for example, with a luminance of one tenth of the maximally achievable luminance. In this case, the beam current of the electron beams EBR, EBG, EBB is equal and is approximately 10% of the maximum beam current for each beam. The beam current of the electron beams EBR, EBG, EBB is then 0.2 rnA.

At such a value of the beam current, the Coulomb repellence between the electron beams EBR, EBG, EBB is substantially negligible so that the voltage difference between V1 and V2 is substantially zero and the beam-shaping means 30 do not substantially change the convergence of the electron beams EBR, EBG, EBB.

The electron beams EBR′, EBG′, EBB′ display a white pixel 52, for example, with a luminance which is equal to the maximally achievable luminance. In this case, the beam current of the electron beams EBR′, EBG′, EBB′ is equal and, for each beam, is equal to the maximum beam current, for example, 2 mA.

The Coulomb repellence between the electron beams EBR′, EBG′, EBB′ near the display screen 3 is then relatively strong. The difference between the voltages V1 and V2 is now, for example, 100 V, so that V1=550 volts, V3=600 volts and V2=650 volts. The electron beams EBR′, EBG′, EBB′ diverge relatively strongly near the beam-shaping means 30 and thus extend at a relatively large angle of incidence to the shadow mask 4. The unwanted Coulomb repellence between the electron beams EBR′, EBG′, EBB′ is compensated in this way and the electron beams EBR′, EBG′, EBB′ land on the corresponding phosphor of the pixel 52. Consequently, color errors in the white pixel 52 due to Coulomb repellence are inhibited.

Although the invention has been described with reference to some embodiments, it should not be considered to be limited to these embodiments. In particular, the invention also comprises any variation of embodiments that can be conceived by those skilled in the art within the protective scope of the appendant claims.

In this respect, non-limitative examples are the reduction of damage of electron source and/or module by positive ions, the compensation of alignment errors occurring during manufacture of the display tube and particularly an assembly of an electron-optical system, or the compensation of a charge of any element in the display tube influencing the path of the electron beam.

Any reference sign placed between parentheses shall not be construed as limiting the claim. Use of the verb “comprise” and its conjugations does not exclude the presence of elements other than those stated in the claims. Use of the article “a” or “an” preceding an element does not exclude the presence of a plurality of such elements.

1. A display tube comprising
an electron source (10R, 10G, 10B) for emitting electrons;
a module (20) comprising a guidance cavity (25R, 25G, 25B) having an entrance aperture (26R, 26G, 26B) for receiving electrons emitted by the electron source (10R, 10G, 10B), an exit aperture (27R, 27G, 27B), and a wall (28R, 28G, 28B) for emitting a secondary electron after receiving an electron, the exit aperture (27R, 27G, 27B) being situated in an end face (22) of the module (20);
beam-shaping means (30) for forming an electron beam (EBR, EBG, EBB) from secondary electrons near the exit aperture (27R, 27G, 27B), and
a display screen (3) for receiving the electron beam (EBR, EBG, EBB) and for generating an image by means of the electron beam (EBR, EBG, EBB),
characterized in that the beam-shaping means (30) are adapted to adjust, in operation, an exiting direction of the electron beam (EBR, EBG, EBB) in conformity with a predetermined application.

2. A display tube as claimed in claim 1, characterized in that the beam-shaping means (30) comprise a deflection electrode (34, 35, 36) having two segments (34A, 34B; 36A, 36B) which, in operation, receive different voltages (V1, V2).

3. A display tube as claimed in claim 1, characterized in that the module (20) has three transport cavities (25R, 25G, 25B) whose exit apertures (27R, 27G, 27B) are aligned in the end face (22) in a first direction for forming an inner electron beam (EBG), a first outer electron beam (EBR) and a second outer electron beam (EBB).

4. A display tube as claimed in claims 2 and 3, characterized in that the deflection electrodes (34, 36) for the outer electron beams (EBR, EBB) have an inner segment (34A) facing the inner electron beam (EBG) and an outer segment (34B) facing away from the inner electron beam (EBG) for changing a mutual exit angle of the electron beams (EBR, EBG, EBB).

5. A display tube as claimed in claim 4, characterized in that the deflection means (2) are provided for changing a landing spot of the electron beams (EBR, EBG, EBB) on the display screen (3), and the mutual exit angle of the electron beams (EBR, EBG, EBB) is dynamically variable in dependence upon the landing spot.

6. A display tube as claimed in claim 5, characterized in that a shadow mask (4) is situated near the display screen (3), which shadow mask has a smaller radius of curvature at least in one direction than a radius of curvature of an inner side of the display screen (3) facing the module (20).

7. A display tube as claimed in claim 3, characterized in that the exiting direction of at least a first of the electron beams (EBR, EBG, EBB) is dynamically variable in dependence upon a beam current of at least the first of the electron beams (EBR, EBG, EBB).

8. A display tube as claimed in claim 2, characterized in that the beam-shaping means (30) comprise a hop electrode (31, 32, 33) for transporting secondary electrons in the guidance cavity (25R, 25G, 25B) substantially towards the exit aperture (27R, 27G, 27B).

9. A display tube as claimed in claim 8, characterized in that the hop electrode (31, 32, 33) and the deflection electrode (34, 35, 36) are situated substantially in the same plane, the hop electrode (31, 32, 33) being situated within an aperture in the deflection electrode (34, 35, 36).

10. A display device comprising a display tube as claimed in any one of claims 1 to 9.
